(19) United States
(12) Patent Application Publication
(10) Pub. No.: US 2026/0147206 A1
(43) Pub. Date: May 28, 2026

(54) HEAD-UP DISPLAY

(71) Applicant: Panasonic Automotive Systems Co., Ltd., Kanagawa (JP)

(72) Inventor: Junichi NONAKA, Osaka (JP)

(73) Assignee: Panasonic Automotive Systems Co., Ltd., Kanagawa (JP)

(21) Appl. No.: 19/085,775

(22) Filed: Mar. 20, 2025

(30) Foreign Application Priority Data
Mar. 29, 2024 (JP) 2024-055850

(51) Int. Cl. G02B 27/01; G02B 7/198

(52) U.S. Cl. CPC G02B 27/0149; G02B 7/198; G02B 27/0179; G02B 2027/015; G02B 2027/0154

(57) ABSTRACT

A head-up display includes: an image generator that emits display light that forms a display image; a second reflective mirror that forms a virtual image on a side opposite to an observer relative to the windshield; and a housing that houses the image generator and the second reflective mirror. The second reflective mirror includes: a base that is elongated and includes a first surface and a second surface, the first surface including a reflective surface that guides the display light to the windshield, the second surface being a rear surface of the first surface; and a raised wall that extends upward from a terminal edge of the second surface and extends in a longitudinal direction of the base. The center portion of the raised wall in the longitudinal direction is lower than each of both end portions of the raised wall in the longitudinal direction.

### CROSS REFERENCE TO RELATED APPLICATION

The present application is based on and claims priority of Japanese Patent Application No. 2024-055850 filed on Mar. 29, 2024.

### FIELD

The present disclosure relates to a head-up display mounted in, for example, a vehicle.

### BACKGROUND

Conventionally, a head-up display mounted in, for example, a vehicle has been proposed (see Patent Literature (PTL) 1). PTL 1 discloses a head-up display including: a display component that emits display light that forms a display image; and a first mirror that forms a virtual image on the side opposite to an observer relative to the display medium by guiding the image displayed by the display component to a display medium. The first mirror includes: a base including a first surface, a second surface that is the rear surface of the first surface, and an edge provided with a rib; and a reflective surface provided on the first surface.

### CITATION LIST

### Patent Literature

PTL 1: Japanese Unexamined Patent Application Publication No. 2022-139310

### SUMMARY

However, the head-up display of PTL 1 can be improved upon.

In view of this, the present disclosure provides a head-up display capable of improving upon the above related art.

A head-up display according to one aspect of the present disclosure is a head-up display head-up display for projecting a virtual image onto a display medium, the head-up display including: an image generator that emits display light that forms a display image; a mirror that forms a virtual image on a side opposite to an observer relative to the display medium by guiding, to the display medium, the display light emitted from the image generator; and a housing that houses the image generator and the mirror. The mirror includes: a base that is elongated and includes a first surface and a second surface, the first surface including a reflective surface that guides the display light to the display medium, the second surface being a rear surface of the first surface; and a raised wall that extends upward from a terminal edge of the second surface and extends in a longitudinal direction of the base. A center portion of the raised wall in the longitudinal direction is lower than each of both end portions of the raised wall in the longitudinal direction.

The head-up display according to one aspect of the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a perspective view illustrating a head-up display, provided in a vehicle, according to an embodiment.

FIG. 2 is a sectional view illustrating a windshield and the head-up display.

FIG. 3 illustrates the head-up display.

FIG. 4 illustrates a head-up display that includes a first rib formed with a recess and a second rib formed with a recess.

FIG. 5 illustrates a head-up display in which the center portion of the first rib and the center portion of the second rib are not formed.

FIG. 6 illustrates a head-up display in which the center portion of the first rib is misaligned with the center portion of the second rib.

FIG. 7 illustrates a head-up display including a second reflective mirror in which the first rib is shorter than the second rib.

FIG. 8 illustrates a head-up display including a second reflective mirror in which the second rib is shorter than the first rib.

FIG. 9 illustrates a head-up display including a rhomboid second reflective mirror.

FIG. 10 illustrates a head-up display that includes a polygonal second reflective mirror with one side missing.

FIG. 11 is a schematic explanatory view illustrating the relationship between a housing and the second reflective mirror of the head-up display according to the present embodiment, and the relationship between a housing and a second reflective mirror of a comparative example.

### DESCRIPTION OF EMBODIMENT

Hereinafter, an exemplary embodiment will be specifically described with reference to the drawings.

Note that the embodiment described below shows either general or specific examples. Numerical values, shapes, materials, components, placement positions and connection forms of the components, and the like shown in the following embodiment are examples and are not intended to limit the present disclosure. Among the components in the following embodiment, components not recited in the independent claim will be described as optional components.

Each of the drawings is a schematic diagram and is not necessarily illustrated exactly. In each of the drawings, the same components are denoted by the same reference numerals.

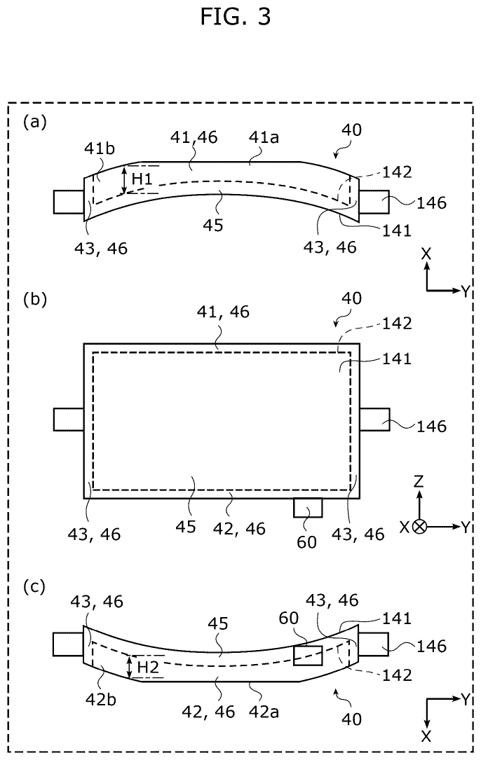

In the following embodiment, in FIG. 2, the front side of the vehicle is defined as the positive X-axis direction, and the right side, when viewed along the front of the vehicle, is defined as the positive Y-axis direction. The upper side in the vertical direction, perpendicular to the positive X-axis and the positive Y-axis directions, is defined as the positive Z-axis direction. The direction of FIG. 2 is also applied in FIG. 3 and subsequent figures.

In the following embodiment, expressions such as rhomboid, X-axis direction, and substantially parallel are used. For example, rhomboid, X-axis direction, and substantially parallel do not necessarily mean perfectly rhomboid, X-axis direction, and parallel, but also mean substantially rhomboid, X-axis direction, and parallel, that is, including a margin of error, such as a few percent. Rhomboid, X-axis direction, and substantially parallel mean rhomboid, X-axis direction, and parallel in the range where the effects of the present disclosure can be achieved. The same applies to cases where there are other expressions using “shape”, “direction”, or “substantially”.

### EMBODIMENT

### Configuration

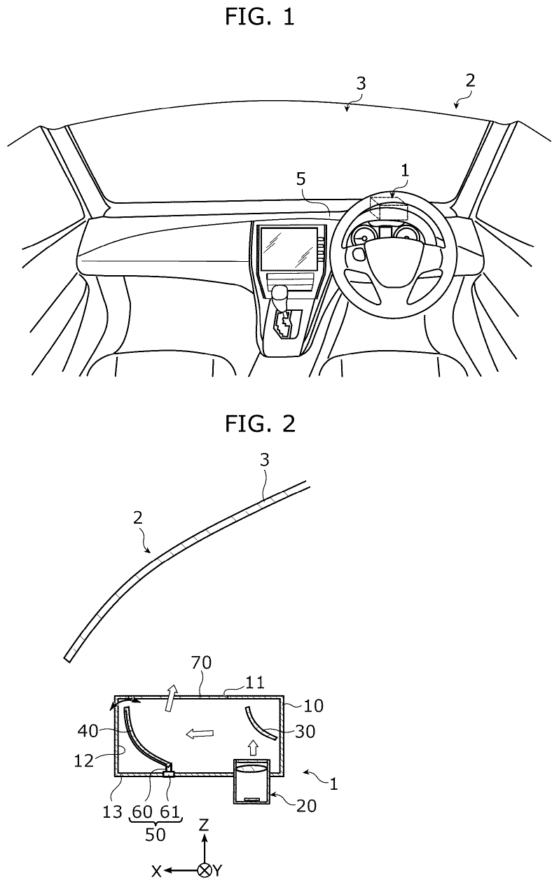

Hereinafter, head-up display 1 according to an embodiment will be described with reference to FIGS. 1 to 11.

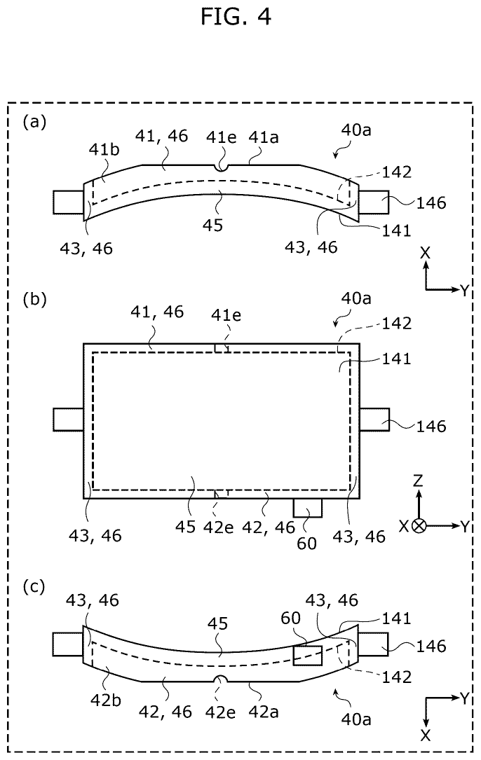

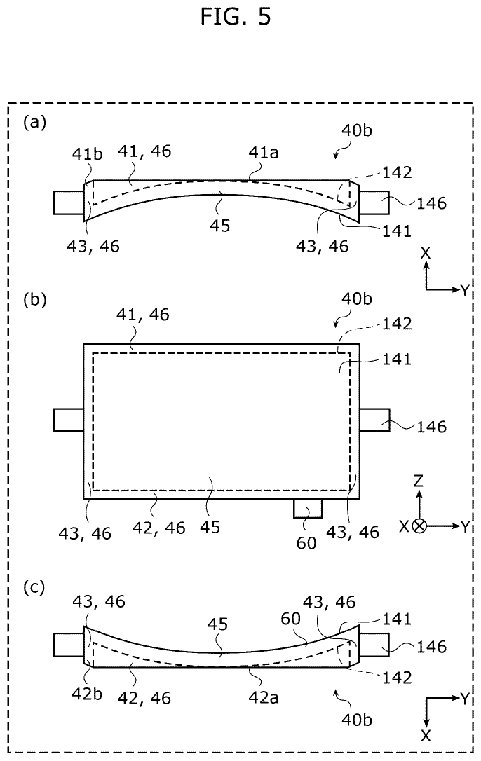

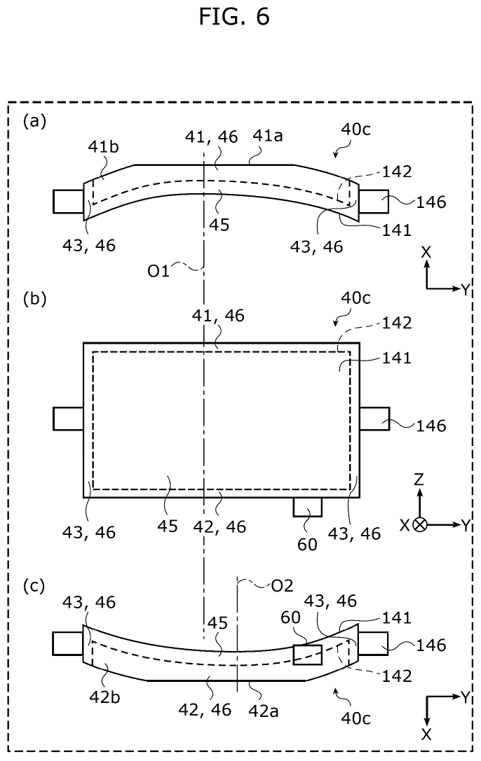

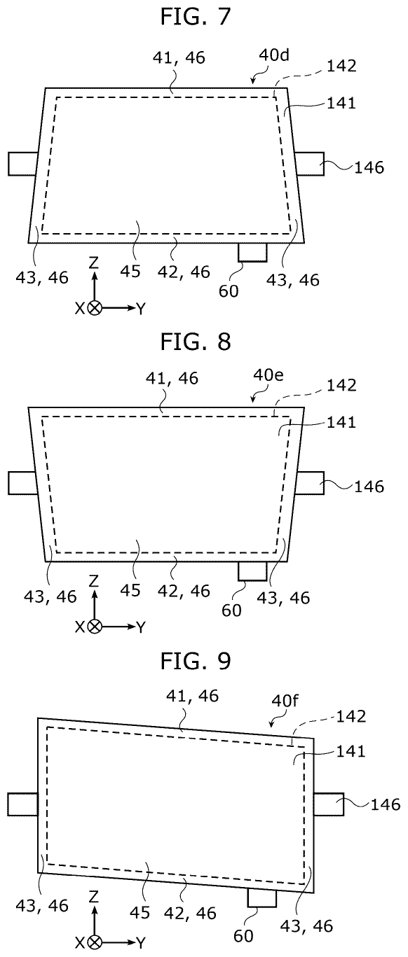

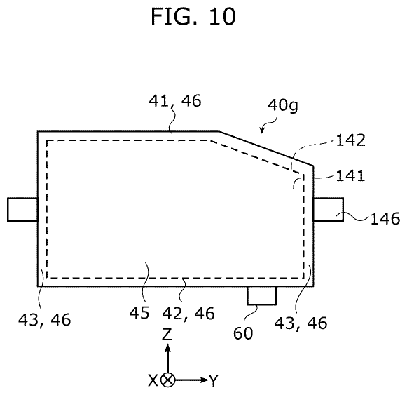

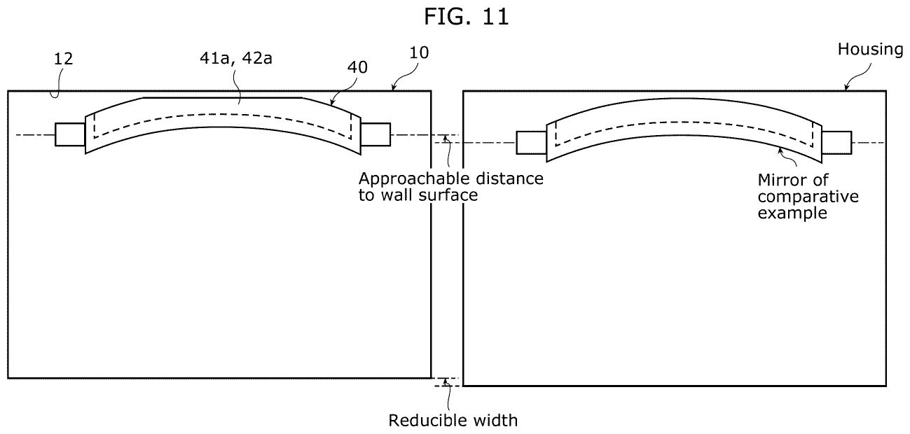

FIG. 1 is a perspective view illustrating head-up display 1, provided in a vehicle, according to an embodiment. FIG. 2 is a sectional view illustrating windshield 3 and head-up display 1. FIG. 3 is a view illustrating head-up display 1. (a) of FIG. 3 illustrates a top view of second reflective mirror 40. (b) of FIG. 3 illustrates a front view of second reflective mirror 40. (c) of FIG. 3 illustrates a bottom view of second reflective mirror 40. FIG. 4 is a view illustrating head-up display 1 that includes first rib 41 and second rib 42 formed with recesses 41e, 42e. (a) of FIG. 4 illustrates a top view of second reflective mirror 40a. (b) of FIG. 4 illustrates a front view of second reflective mirror 40a. (c) of FIG. 4 illustrates a bottom view of second reflective mirror 40a. FIG. 5 is a view illustrating head-up display 1 in which center portion 41a of first rib 41 and center portion 42a of second rib 42 are not formed. (a) of FIG. 5 illustrates a top view of second reflective mirror 40b. (b) of FIG. 5 illustrates a front view of second reflective mirror 40b. (c) of FIG. 5 illustrates a bottom view of second reflective mirror 40b. FIG. 6 is a view illustrating head-up display 1 formed so that center portion 41a of first rib 41 is misaligned with center portion 42a of second rib 42. (a) of FIG. 6 illustrates a top view of second reflective mirror 40c. (b) of FIG. 6 illustrates a front view of second reflective mirror 40c. (c) of FIG. 6 illustrates a bottom view of second reflective mirror 40c. FIG. 7 is a diagram illustrating head-up display 1 that includes second reflective mirror 40d in which first rib 41 is shorter than second rib 42. FIG. 8 is a diagram illustrating head-up display 1 that includes second reflective mirror 40e in which second rib 42 is shorter than first rib 41. FIG. 9 is a diagram illustrating head-up display 1 that includes a rhomboid second reflective mirror 40f. FIG. 10 is a diagram illustrating head-up display 1 that includes a polygonal second reflective mirror 40g with one side missing. FIG. 11 is a schematic explanatory diagram illustrating the relationship between housing 10 and second reflective mirror 40 of head-up display 1 according to the present embodiment, and the relationship between a housing and a second reflective mirror of a comparative example.

As illustrated in FIG. 1, head-up display 1 is disposed, for example, on dashboard 5 (also referred to as an instrument panel) of vehicle 2. Windshield 3 (also referred to as a front shield) is disposed above dashboard 5 of vehicle 2. Head-up display 1 is disposed in dashboard 5.

Head-up display 1 is provided in vehicle 2. Head-up display 1 can project a virtual image onto a display medium. Specifically, head-up display 1 projects a display image onto an object capable of transmitting and reflecting light, and forms a virtual image on the display medium on the side opposite to an observer. For example, head-up display 1 can reflect display light that represents a display image, emitted from image generator 20, onto windshield 3 as a display medium to display a virtual image represented by the image light for a user such as a driver. That is, head-up display 1 projects the display light emitted from image generator 20 onto the front of windshield 3, thereby displaying a display image indicated by the display light on windshield 3. The display image projected onto windshield 3 of vehicle 2 is thus visible by the user.

Here, the display light is light representing information of a display image including numbers, characters, figures, and the like, and is displayed as a virtual image in the front of windshield 3. The display image is a still image or a moving image, and is an image of numbers, characters, figures, and the like.

As illustrated in FIGS. 2 and 3, head-up display 1 includes housing 10, image generator 20, first reflective mirror 30, second reflective mirror 40, drive mechanism 50, and cover 70.

Housing 10 is an enclosure that houses image generator 20, first reflective mirror 30, and second reflective mirror 40. Housing 10 constitutes the outer shell of head-up display 1. Housing 10 is fixed to vehicle 2 while attached to dashboard 5 or attached to a bracket disposed on a vehicle reinforcement. Housing 10 is made of resin material or metal material.

Opening 11 for placing cover 70 is formed on the positive Z-axis direction side of housing 10. Display light, formed by a display image generated by image generator 20, passes through opening 11.

Image generator 20 generates a display image and outputs display light that forms the generated display image so that the display image is projected onto windshield 3. More specifically, image generator 20 emits display light from the display component. The display light emitted from the display component of image generator 20 is reflected by first reflective mirror 30, then also reflected by second reflective mirror 40, passes through opening 11, enters cover 70, passes therethrough, and is then emitted from head-up display 1 to be projected onto windshield 3. That is, image generator 20 can project a predetermined display image onto windshield 3 by emitting display light. When the display light is reflected by windshield 3, the user can recognize a virtual image. Image generator 20 is, for example, a liquid crystal display device including a liquid crystal display and other components.

Image generator 20 includes a display component, a container, a light-emitting module, and a condenser lens.

The display component is a liquid crystal display element such as a liquid crystal display. Note that the display component may be a device other than a liquid crystal display, such as an organic light-emitting diode (electroluminescence) or a fluorescent display (seven-segment display). In the display component, the light emitted from the light-emitting module is emitted from the rear surface side of the display component so that the emitting surface emits light. In the display component, display light, indicating a display image including numbers, characters, figures, and the like, is emitted from the emitting surface in response to a control instruction from an electronic control unit (ECU) installed in vehicle 2.

The display component is driven by DC power obtained from the power supply in vehicle 2.

The container is an enclosure that houses a display component, a light-emitting module, and a condenser lens. The container is disposed on the bottom plate of housing 10.

The light-emitting module includes a light source and a substrate on which the light source is mounted. The light source is mounted on the substrate. The substrate is held to emit light toward the display component from the rear side of the display component through the condenser lens. The light source is formed by, for example, light-emitting diodes. For example, the light source is driven by DC power obtained from the power supply in vehicle 2.

The condenser lens is disposed on the light emission direction side of the light source and disposed on an optical path between the light source and the display component. The condenser lens emits light emitted from the light source toward the display component.

First reflective mirror 30 reflects the display light emitted from image generator 20 toward second reflective mirror 40. Second reflective mirror 40 reflects the display light emitted from image generator 20 toward cover 70 through opening 11. That is, second reflective mirror 40 forms a virtual image on the side opposite to the observer relative to windshield 3 by guiding the display light, which forms a display image and is emitted from image generator 20, to windshield 3.

Specifically, first reflective mirror 30 and second reflective mirror 40 are arranged in housing 10 so as to face each other while being separated by a predetermined distance. More specifically, first reflective mirror 30 is disposed on the negative X-axis direction side of housing 10 so as to face the emitting surface of image generator 20 and second reflective mirror 40, which are arranged on the negative X-axis direction side of housing 10. First reflective mirror 30 and second reflective mirror 40 are arranged between image generator 20 and opening 11. Second reflective mirror 40 faces first reflective mirror 30 and is disposed on the positive X-axis direction side of first reflective mirror 30. That is, second reflective mirror 40 is disposed in line with first reflective mirror 30 in the X-axis direction.

First reflective mirror 30 and second reflective mirror 40 are concave mirrors, convex mirrors, or plane mirrors. In the present embodiment, each of first reflective mirror 30 and second reflective mirror 40 is a concave mirror with a free-form surface. In the present embodiment, each of first reflective mirror 30 and second reflective mirror 40 is a rectangular mirror that is elongated in the Y-axis direction. Note that the shapes of first reflective mirror 30 and second reflective mirror 40 are not particularly limited, and may be polygonal or circular.

Second reflective mirror 40 is swingable about the Y-axis direction. In this case, the position of the display image projected onto windshield 3 can be adjusted. Second reflective mirror 40 may swing by manual operation or electric operation using drive mechanism 50. In the present embodiment, second reflective mirror 40 swings by electric operation using drive mechanism 50.

Second reflective mirror 40 includes elongated base 45, raised wall 46, and shaft 146.

Base 45 is made of a resin-molded product formed by injection molding a resin, such as polycarbonate, or another material, such as glass.

Base 45 has a rectangular shape. Note that the shape of base 45 is not limited to a rectangular shape. The shape of base 45 may be any other known shape.

Base 45 includes first surface 141 with a reflective surface that guides display light to windshield 3, and second surface 142 that is the rear surface of first surface 141.

First surface 141 is mirror-processed to be capable of reflecting display light. First surface 141 may include a reflective surface formed by a light reflecting film, a light reflecting plate, or the like. The entire surface of first surface 141 or the center portion of first surface 141 may be a reflective surface.

First surface 141 has a concave shape in the present embodiment. Therefore, first surface 141 has a spherical shape or an aspherical shape. Note that first surface 141 may have a convex shape or a planar shape. First surface 141 as described above is a concave mirror, a convex mirror, or a plane mirror.

Raised wall 46 extends upward from the terminal edge of second surface 142 and extends in the longitudinal direction of base 45. That is, raised wall 46 is a frame-shaped body formed along the outer peripheral edge of base 45. Raised wall 46 may be formed over the entire periphery of the outer peripheral edge of base 45, or may not be formed by cutting off a portion. In the present embodiment, the longitudinal direction is a direction parallel to the Y-axis direction.

Specifically, the longitudinal center portion of raised wall 46 is lower than longitudinal end portions 41b, 42b of raised wall 46. For example, as illustrated in (a) to (c) of FIG. 3, when the side surface of second reflective mirror 40 is viewed in the short direction of second reflective mirror 40, raised wall 46 in the longitudinal center portion is cut off to form a plane that is substantially parallel to the longitudinal direction of base 45. Specifically, raised wall 46 includes: first rib 41 extending in the longitudinal direction; and second rib 42 extending in the longitudinal direction. In the present embodiment, the short direction is a direction orthogonal to the longitudinal direction.

First rib 41 is disposed closer to windshield 3 than second rib 42 in base 45, that is, closer to opening 11 of housing 10 than (on the positive Z-axis direction side of) second rib 42. Second rib 42 is disposed farther from windshield 3 than first rib 41, and further from opening 11 of housing 10 than (on the negative Z-axis direction side of) first rib 41. In the present embodiment, first rib 41 and second rib 42 are substantially parallel.

Second reflective mirror 40 is rotatably disposed inside housing 10, and is rotatably supported, substantially directly facing wall surface 12 inside housing 10. Second reflective mirror 40 is supported by housing 10 in such an orientation that first rib 41 is closer to wall surface 12 than second rib 42, even when second reflective mirror 40 rotates. Wall surface 12 is a wall surface on the positive X-axis direction side of housing 10 and on the front side of vehicle 2.

Second reflective mirror 40 rotates inside housing 10, but does not contact (interfere with) housing 10 even when reflective mirror 40 rotates.

More specifically, even when second reflective mirror 40 rotates, first rib 41 does not contact wall surface 12 of housing 10. The height of center portion 41a of first rib 41 is such that second reflective mirror 40 does not contact wall surface 12 even when second reflective mirror 40 rotates. That is, a cut is formed in center portion 41a of first rib 41.

Furthermore, even when second reflective mirror 40 rotates, second rib 42 does not contact the bottom wall surface 13 of housing 10. That is, the height of center portion 42a of second rib 42 is such that second reflective mirror 40 does not contact wall surface 13 even when second reflective mirror 40 rotates. That is, a cut is formed in center portion 42a of second rib 42.

The cuts in center portion 41a of first rib 41 and center portion 42a of second rib 42 are linearly formed. The cut in center portion 41a of first rib 41 and the cut in center portion 42a of second rib 42 are not limited to linear shapes. For example, the cut in center portion 41a of first rib 41 and the cut in center portion 42a of second rib 42 have a curved or other shapes. The cut in center portion 41a of first rib 41 and the cut in center portion 42a of second rib 42 may have other known shapes.

As illustrated in (a) to (c) of FIG. 4, in second reflective mirror 40a, recesses 41e, 42e may be formed in the cut in center portion 41a of first rib 41 and the cut in center portion 42a of second rib 42. That is, the cut in center portion 41a of first rib 41 and the cut in center portion 42a of second rib 42 may be further partially cut.

As illustrated in (a) to (c) of FIG. 4, the shape of recess 41e in center portion 41a of first rib 41 may be any shape, and the number of recesses 41e in center portion 41a of first rib 41 may be one or more, and is not particularly limited. The shape of recess 42e in center portion 42a of second rib 42 may be any shape, and the number of recesses 42e in center portion 42a of second rib 42 may be one or more, and is not particularly limited.

As illustrated in (a) to (c) of FIG. 5, in second reflective mirror 40b, the cut in center portion 41a of first rib 41 and the cut in center portion 42a of second rib 42 of second reflective mirror 40b may each have zero height in one portion. That is, second reflective mirror 40b may be formed with a portion where the height of second surface 142 of base 45 is the same as (flush with) the height of first rib 41 and the height of second rib 42.

Compared to the conventional head-up display in which the center portion of the first rib and the center portion of the second rib are not cut off, in head-up display 1 of the present embodiment, second reflective mirror 40b can be disposed as close as possible to wall surface 12 of housing 10 (wall surface 12 on the front side of vehicle 2). For this reason, second reflective mirror 40b is disposed in housing 10 such that the distance between center portion 41a of first rib 41 and wall surface 12 is shorter than the distance between each longitudinal end portion 41b of first rib 41 and wall surface 12.

As illustrated in (a) to (c) of FIG. 6, in second reflective mirror 40c, the position of longitudinal center portion 41a of first rib 41 may differ from the position of longitudinal center portion 42a of second rib 42. That is, in second reflective mirror 40c, center portion 41a of first rib 41 having the lowest height (the dot-dash line passing through the center of the cut of first rib 41) is formed at a position different from center portion 42a of second rib 42 having the lowest height (the dot-dash line passing through the center of the cut of second rib 42). That is, dot-dash line O1 and dot-dash line O2 are parallel to, but not consistent with, each other. As illustrated in (a) to (c) of FIG. 6, second reflective mirror 40c can be said to have an asymmetric shape with respect to a straight line extending in the short direction that intersects the longitudinal direction.

In the present embodiment, as illustrated in FIGS. 7 and 8, second reflective mirrors 40d, 40e may each be asymmetric with respect to a straight line extending in the longitudinal direction (a straight line parallel to the Y-axis direction). That is, each of second reflective mirrors 40d, 40e is not symmetric with respect to a straight line parallel to the Y-axis direction.

For example, the length of first rib 41 and the length of second rib 42 may be different. As illustrated in FIG. 7, in second reflective mirror 40d, the length of first rib 41 may be shorter than the length of second rib 42. In this case, second reflective mirror 40d may be trapezoidal in shape with first rib 41 and second rib 42 substantially parallel to each other. As illustrated in FIG. 8, in second reflective mirror 40e, the length of first rib 41 may be longer than the length of second rib 42. In this case, second reflective mirror 40e may be trapezoidal in shape with first rib 41 and second rib 42 substantially parallel to each other.

In the present embodiment, as illustrated in FIGS. 9 and 10, second reflective mirror 40 may have a shape asymmetric with respect to a straight line extending in the short direction (Z-axis direction) that intersects the longitudinal direction (Y-axis direction). That is, second reflective mirror 40 is not line-symmetric with respect to a straight line orthogonal to the Y-axis direction.

For example, as illustrated in FIG. 9, in second reflective mirror 40f, the length of first rib 41 may be equal to the length of second rib 42, and the lengths of the pair of third ribs 43 may be equal to each other. In this case, second reflective mirror 40f may have a rhomboid shape. As illustrated in FIG. 10, second reflective mirror 40g may have a polygonal shape with a portion cut off. In this case, first rib 41 or second rib 42 may be bent. FIG. 10 illustrates a case where first rib 41 is bent and second rib 42 is straight. In second reflective mirror 40f, the length of first rib 41 may differ from the length of second rib 42, and the lengths of the pair of third ribs 43 may differ from each other.

As illustrated in (a) to (c) of FIG. 3, height H1 of first rib 41 is greater than height H2 of second rib 42. That is, the height of center portion 41a of first rib 41 is greater than the height of center portion 42a of second rib 42, and the heights of both end portions 41b of first rib 41 are greater than the heights of both end portions 42b of second rib 42.

As illustrated in FIG. 11, second reflective mirror 40 has a structure with the center portion of raised wall 46 cut off. Therefore, second reflective mirror 40 can be disposed as close as possible to wall surface 12 of housing 10. As second reflective mirror 40 can be disposed as close as possible to wall surface 12 of housing 10, housing 10 can be reduced in size.

Raised wall 46 further includes a pair of third ribs 43 extending in the short direction arranged at both end portions 41b of first rib 41 and both end portions 42b of second rib 42.

One third rib 43 of the pair of third ribs 43 connects one end (the end on the positive Y-axis direction side) of first rib 41 and one end (the end on the positive Y-axis direction side) of second rib 42. The other third rib 43 of the pair of third ribs 43 connects the other end (the end on the negative Y-axis direction side) of first rib 41 and the other end (the end on the negative Y-axis direction side) of second rib 42.

The heights of the pair of third ribs 43 may be equal to the heights of both end portions 41b of first rib 41 and the heights of both end portions 42b of second rib 42. The heights of the pair of third ribs 43 may be equal to each other. Note that the heights of the pair of third ribs 43 may differ from the heights of both end portions 41b of first rib 41 and the heights of both end portions 42b of second rib 42. The heights of the pair of third ribs 43 may differ from each other.

Shafts 146 are arranged at both longitudinal ends of second reflective mirror 40, that is, at both ends in the Y-axis direction. Shafts 146 are coupled to the pair of third ribs 43 and base 45. Since shafts 146 are pivotally supported by housing 10, second reflective mirror 40 is pivotally supported by housing 10.

Raised wall 46 is made of a resin-molded product formed integrally with base 45 by injection molding a resin, such as polycarbonate, or another material, such as glass.

Although second reflective mirror 40 has been described, first reflective mirror 30 may have the same configuration and function as second reflective mirror 40.

Drive mechanism 50 is provided on the side surface of second reflective mirror 40. In the present embodiment, drive mechanism 50 is provided on second rib 42 of second reflective mirror 40.

As illustrated in FIG. 2, drive mechanism 50 includes gear 60 and drive component 61.

Gear 60 can rotate second reflective mirror 40 about the axis along the longitudinal direction. Gear 60 is disposed on second rib 42.

Drive component 61 is disposed on the bottom of housing 10 below second reflective mirror 40 and is connected to gear 60. In the present embodiment, drive component 61 is an electric motor capable of rotating second reflective mirror 40 by transmitting a driving force to gear 60. Drive component 61 performs driving so that the angle (orientation) of second reflective mirror 40 can be adjusted.

Cover 70 is supported by housing 10 to cover opening 11 of housing 10. Cover 70 is disposed on the positive Z-axis direction side of first reflective mirror 30, second reflective mirror 40, and image generator 20.

Cover 70 is made of a translucent resin material such as polycarbonate (PC), acrylic, or a laminate thereof, or a polarizing plate. Since the display light passes through opening 11, the display light transmitted through cover 70 is projected onto windshield 3.

Cover 70 also serves as an antifouling cover for inhibiting dust from entering housing 10. For example, a hard coat treatment may be applied to the surface of cover 70 on the side of windshield 3. In this case, even if dust adheres to the surface, dirt can be easily wiped off. The surface of cover 70 on the side of windshield 3 is a surface on the positive Z-axis direction side of cover 70 and is an emitting surface from which image light is emitted. The surface of cover 70 may have an antireflection coating.

### Operations and Effects

Next, the operations and effects of head-up display 1 according to the present embodiment will be described.

In the head-up display of Patent Literature (PTL) 1, a rib is provided on a base to ensure the rigidity of the first mirror, and increases in weight of the first mirror and manufacturing cost can be inhibited. However, in the head-up display, further reduction in weight and further reduction in manufacturing cost are required. In the head-up display of PTL 1, there is a problem that larger ribs increase the weight of the first mirror, leading to increases in the weight of the head-up display and manufacturing cost.

Therefore, as described above, head-up display 1 according to the present embodiment is head-up display 1 for projecting a virtual image onto a display medium (windshield 3). Head-up display 1 includes: image generator 20 that emits display light that forms a display image; a mirror (second reflective mirrors 40 to 40g) that form a virtual image on the side opposite to the observer relative to the display medium (windshield 3) by guiding the display light, which forms the display image and is emitted from image generator 20, to the display medium (windshield 3); and housing 10 that houses image generator 20 and the mirror (second reflective mirrors 40 to 40g). The mirror (second reflective mirrors 40 to 40g) includes: elongated base 45 that includes first surface 141, including a reflective surface that guides the display light to the display medium (windshield 3), and second surface 142, which is the rear surface of first surface 141; and raised wall 46 that extends upward from the terminal edge of second surface 142 and extends in the longitudinal direction of base 45. Longitudinal center portions 41a, 42a of raised wall 46 are lower than longitudinal end portions 41b, 42b of raised wall 46.

In this case, since center portions 41a, 42a of raised wall 46 on each of second reflective mirrors 40 to 40g have partially cut-off structures, an increase in the weight of each of second reflective mirrors 40 to 40g can be inhibited. In addition, the material cost of second reflective mirrors 40 to 40g can be reduced accordingly.

Therefore, according to this head-up display 1, increases in weight and manufacturing cost can be inhibited.

In particular, since raised walls 46 are formed on second reflective mirrors 40 to 40g, the distortion of second reflective mirrors 40 to 40g can be inhibited by ensuring the rigidity of second reflective mirrors 40 to 40g. Therefore, when head-up display 1 is provided in a vehicle, even if second reflective mirrors 40 to 40g vibrate in a predetermined frequency band, the vibration can be reduced by ensuring the rigidity of second reflective mirrors 40 to 40g. This can inhibit the deterioration of image quality in the display image reflected by each of second reflective mirrors 40 to 40g and displayed on windshield 3.

Further, in head-up display 1 according to the present embodiment, raised wall 46 includes: first rib 41 extending in the longitudinal direction; and second rib 42 extending in the longitudinal direction and disposed at a position farther from display medium (windshield 3) than first rib 41. The mirror (second reflective mirrors 40 to 40g) is rotatably supported, substantially directly facing wall surface 12 inside housing 10, and is supported in such an orientation that first rib 41 is closer to wall surface 12 than second rib 42. The height of center portion 41a of first rib 41 and the height of center portion 42a of second rib 42 are such that the mirror (second reflective mirrors 40 to 40g) does not contact housing 10 even during the rotation.

With this configuration, even when second reflective mirrors 40 to 40g are rotatably supported inside housing 10, first rib 41 and second rib 42 of each of second reflective mirrors 40 to 40g are hardly brought into contact with housing 10.

In addition, since center portion 41a of first rib 41 and center portion 42a of second rib 42 are cut off, each of second reflective mirrors 40 to 40g can be disposed closer to wall surface 12 of housing 10 compared to the reflective mirror of the comparative example, as illustrated in FIG. 11. That is, each of second reflective mirrors 40 to 40g can be disposed closer to wall surface 12 of housing 10 by a distance corresponding to the height at which center portion 41a of first rib 41 and center portion 42a of second rib 42 are cut off. Therefore, housing 10 can be made smaller by a width corresponding to the approached distance.

Further, in head-up display 1 according to the present embodiment, raised wall 46 includes: first rib 41 extending in the longitudinal direction; and second rib 42 extending in the longitudinal direction and disposed at a position farther from the display medium (windshield 3) than first rib 41. The mirror (second reflective mirrors 40 to 40g) is rotatably supported, substantially directly facing wall surface 12 inside housing 10, and is supported in such an orientation that first rib 41 is closer to wall surface 12 than second rib 42. The distance between center portion 41a of first rib 41 and wall surface 12 is shorter than the distance between each longitudinal end portion 41b of first rib 41 and wall surface 12.

With this configuration, each of second reflective mirrors 40 to 40g can be disposed in an inclined orientation in housing 10. Therefore, an increase in the size of housing 10 in the height direction (Z-axis direction) can be inhibited compared to the case where each of second reflective mirrors 40 to 40g is disposed in housing 10 in an upright state.

In addition, since center portion 41a of first rib 41 and center portion 42a of second rib 42 are cut off, each of second reflective mirrors 40 to 40g can be disposed closer to wall surface 12 of housing 10 compared to the reflective mirror of the comparative example, as illustrated in FIG. 11. That is, each of second reflective mirrors 40 to 40g can be disposed closer to wall surface 12 of housing 10 by a distance corresponding to the height at which center portion 41a of first rib 41 and center portion 42a of second rib 42 are cut off. Therefore, housing 10 can be made smaller by a width corresponding to the approached distance.

Further, in head-up display 1 according to the present embodiment, the mirror (second reflective mirrors 40d to 40g) has an asymmetric shape with respect to a straight line extending in the longitudinal direction.

With this configuration, when second reflective mirrors 40d to 40g are injection-molded, a better balance of resin filling is expected to ensure uniform cure shrinkage during cooling. Therefore, it can be expected to obtain second reflective mirrors 40d to 40g each including first surface 141 of excellent quality.

Even second reflective mirrors 40d to 40g with an asymmetric shape are used, a display image can be displayed on windshield 3. Therefore, the degree of freedom in the shape of head-up display 1 is hardly compromised.

Further, in head-up display 1 according to the present embodiment, height H1 of first rib 41 is greater than height H2 of second rib 42.

With this configuration, when second reflective mirrors 40 to 40g are injection-molded, a better balance of resin filling is expected to ensure uniform cure shrinkage during cooling. Therefore, it can be expected to obtain second reflective mirrors 40 to 40g each including first surface 141 of excellent quality.

Head-up display 1 according to the present embodiment further includes: gear 60 that rotates the mirror (second reflective mirrors 40 to 40g) about the axis along the longitudinal direction; and drive component 61 that is disposed at the bottom of housing 10 below the mirror (second reflective mirrors 40 to 40g) and is connected to gear 60.

With this configuration, when second reflective mirrors 40 to 40g are injection-molded, a better balance of resin filling is expected to ensure uniform cure shrinkage during cooling. Therefore, it can be expected to obtain second reflective mirrors 40 to 40g each including first surface 141 of excellent quality.

Further, in head-up display 1 according to the present embodiment, longitudinal center portion 41a of first rib 41 differs from the position of longitudinal center portion 42a of second rib 42.

With this configuration, when second reflective mirror 40c is injection-molded, a better balance of resin filling is expected to ensure uniform cure shrinkage during cooling. Therefore, it can be expected to obtain second reflective mirror 40c including first surface 141 of excellent quality.

Further, in head-up display 1 according to the present embodiment, the mirror (second reflective mirrors 40f, 40g) has a shape asymmetric with respect to a straight line extending in the short direction that intersects the longitudinal direction.

With this configuration, when the rotational axes of second reflective mirrors 40f, 40g are disposed to be inclined with respect to the bottom surface of housing 10, the lengths of second reflective mirrors 40f, 40g in the height direction (Z-axis direction) can be reduced. Therefore, an increase in the size of housing 10 in the height direction can be inhibited.

### OTHER VARIATIONS, ETC.

Although the head-up display according to the present disclosure has been described based on the embodiment described above, the present disclosure is not limited to the embodiment. Ones obtained by applying various modifications conceivable by those skilled in the art to the embodiment may also be included within the scope of the present disclosure, as long as they do not depart from the gist of the present disclosure.

Note that the present disclosure also includes forms obtained by applying various modifications conceivable by those skilled in the art to the above embodiment, and forms realized by arbitrarily combining components and functions in the embodiment without departing from the gist of the present disclosure.

While various embodiments have been described herein above, it is to be appreciated that various changes in form and detail may be made without departing from the spirit and scope of the present disclosure as presently or hereafter claimed.

### FURTHER INFORMATION ABOUT TECHNICAL BACKGROUND TO THIS APPLICATION

The disclosure of the following patent application including specification, drawings, and claims is incorporated herein by reference in their entirety: Japanese Patent Application No. 2024-055850 filed on Mar. 29, 2024.

### INDUSTRIAL APPLICABILITY

The present disclosure is applicable to mobile objects such as vehicles, for example.

1. A head-up display for projecting a virtual image onto a display medium, the head-up display comprising:
an image generator that emits display light that forms a display image;
a mirror that forms a virtual image on a side opposite to an observer relative to the display medium by guiding, to the display medium, the display light emitted from the image generator; and
a housing that houses the image generator and the mirror,
wherein the mirror includes:
a base that is elongated and includes a first surface and a second surface, the first surface including a reflective surface that guides the display light to the display medium, the second surface being a rear surface of the first surface; and
a raised wall that extends upward from a terminal edge of the second surface and extends in a longitudinal direction of the base, and
a center portion of the raised wall in the longitudinal direction is lower than each of both end portions of the raised wall in the longitudinal direction.

2. The head-up display according to claim 1,
wherein the raised wall includes: a first rib extending in the longitudinal direction; and a second rib extending in the longitudinal direction and disposed at a position farther from the display medium than the first rib,
the mirror is rotatably supported, substantially directly facing a wall surface inside the housing, and is supported in an orientation where the first rib is closer to the wall surface than the second rib, and
a height of a center portion of the first rib and a height of a center portion of the second rib are set to prevent the mirror from contacting the housing, even when the mirror rotates.

3. The head-up display according to claim 1,
wherein the raised wall includes: a first rib extending in the longitudinal direction; and a second rib extending in the longitudinal direction and disposed at a position farther from the display medium than the first rib,
the mirror is rotatably supported, substantially directly facing a wall surface inside the housing, and is supported in an orientation where the first rib is closer to the wall surface than the second rib, and
a distance between the wall surface and a center portion of the first rib is shorter than a distance between the wall surface and each of both end portions of the first rib in the longitudinal direction.

4. The head-up display according to claim 1,
wherein the mirror has an asymmetric shape with respect to a straight line extending in the longitudinal direction.

5. The head-up display according to claim 3,
wherein a height of the first rib is greater than a height of the second rib.

6. The head-up display according to claim 5, further comprising:
a gear that rotates the mirror about an axis along the longitudinal direction; and
a drive component that is disposed at a bottom of the housing below the mirror and is connected to the gear.

7. The head-up display according to claim 3,
wherein the center portion of the first rib in the longitudinal direction is positioned differently from a center portion of the second rib in the longitudinal direction.

8. The head-up display according to claim 1,
wherein the mirror has a shape asymmetric with respect to a straight line extending in a short direction that intersects the longitudinal direction.
